(19) United States
(12) Patent Application Publication
(10) Pub. No.: US 2025/0376609 A1
(43) Pub. Date: Dec. 11, 2025

(54) ELECTRICALLY CONDUCTIVE ACRYLIC PRESSURE SENSITIVE ADHESIVE TAPES COMPRISING MOISTURE BARRIER LAYER

(71) Applicant: 3M INNOVATIVE PROPERTIES COMPANY, St. Paul, MN (US)

(72) Inventors: Jeongwan Choi, Kyonggi-Do (KR); Hayanmaeum Kim, Gyeonggi-do (KR)

(21) Appl. No.: 19/312,759

(22) Filed: Aug. 28, 2025

Related U.S. Application Data
(62) Division of application No. 16/497,527, filed on Sep. 25, 2019, now abandoned.

(30) Foreign Application Priority Data
May 12, 2017 (KR) 10-2017-0059356

(51) Int. Cl. C09J 133/12; C08K 3/08; C09J 7/28; C09J 7/38; C09J 7/40; C09J 9/02; C09J 133/08

(52) U.S. Cl. CPC C09J 133/12; C09J 7/28; C09J 7/385; C09J 7/401; C09J 9/02; C09J 133/08; C08K 3/08; C08K 2003/0862; C08K 2201/001; C09J 2301/302; C09J 2301/314; C09J 2301/408; C09J 2400/163; C09J 2429/001; C09J 2433/00

(57) ABSTRACT

A pressure sensitive adhesive tape includes a substrate layer including metal, an adhesive layer stacked on one surface of the substrate layer and including an acrylic adhesive polymer resin and a conductive filler including metal, and a release layer stacked on one surface of the adhesive layer. The release layer includes a moisture barrier layer that includes a substrate film having one surface release-treated and a barrier coating layer.

### CROSS REFERENCE TO RELATED APPLICATIONS

This application is a divisional of U.S. application Ser. No. 16/497,527, filed Sep. 25, 2019, which is a US 371 Application based on PCT/IB2018/053089, filed on May 3, 2018, which claims the benefit of Korean Application No. 10-2017-0059356, filed May 12, 2017, the disclosures of which are incorporated by reference in their entireties herein.

### TECHNICAL FIELD

The present disclosure relates to an electrically conductive acrylic pressure sensitive adhesive tape including a moisture barrier layer in a release layer, and to an electrically conductive acrylic pressure sensitive adhesive tape, which can enhance adhesion by preventing reduction of adhesion of an acrylic adhesive layer caused by moisture.

### BACKGROUND ART

A typical electrically conductive acrylic pressure sensitive adhesive tape includes an adhesive layer including an adhesive polymer resin including a carboxylic acid component, and a substrate layer containing a metallic component. Such an acrylic pressure sensitive adhesive tape may cause metallocarboxylate by metal ions moving from the substrate layer to the adhesive layer and reacting with the carboxylic acid component of the adhesive layer (see page 462 of Handbook of pressure sensitive adhesive technology and applications). The metallocarboxylate has problems that the adhesion of the adhesive layer is degraded and a shelf life of the tape is reduced. In particular, the metal ions move more actively in a high-humidity environment.

To solve the above-described problems, an adhesive tape substituting an acid functional group of an acrylic copolymer with a non-acid non-polar monopolymer such as N-vinylpyrrolidone has been suggested (see Korean Patent Registration No. 10-1182944). However, the adhesive tape has no acid functional group and thus may have poor adhesion. Alternatively, there has been suggested a method for waterproofing by sealing the adhesive tape, but this has problems that a physical damage to the adhesive tape may be caused and a separate sealing process is required.

### PRIOR DOCUMENTS

### Patent Document

(Patent Document 1) Korean Patent Registration No. 10-1182944

### Non-Patent Document

(Non-patent document 1) Handbook of pressure sensitive adhesive technology and applications

### SUMMARY

### Technical Problem

Accordingly, the inventors of the present disclosure tried to manufacture an adhesive tape that enhances adhesion by preventing reduction of adhesion of an acrylic adhesive layer caused due to moisture. As a result, the inventors of the present disclosure have completed the present invention by manufacturing an adhesive tape in a new form, including a moisture barrier layer in a release layer.

Accordingly, an object of the present disclosure is to provide an acrylic pressure sensitive adhesive tape which enhances adhesion by preventing reduction of adhesion of an acrylic adhesive layer caused due to moisture, by including a moisture barrier layer in a release layer.

### Technical Solution

To achieve the above-described object, the present disclosure provides a pressure sensitive adhesive tape, comprising:
a substrate layer including metal;
an adhesive layer stacked on one surface of the substrate layer, and including an acrylic adhesive polymer resin; and
a release layer stacked on one surface of the adhesive layer, wherein the release layer includes a moisture barrier layer.

### Advantageous Effects

The pressure sensitive adhesive tape according to the present disclosure prevents reduction of adhesion of the adhesive layer caused by moisture in a high-humidity environment, and has enhanced adhesion.

### BRIEF DESCRIPTION OF THE DRAWINGS

FIGS. 1 to 6 are schematic diagrams of a pressure sensitive adhesive tape according to one embodiment of the present disclosure.

### DETAILED DESCRIPTION

A pressure sensitive adhesive tape of the present disclosure includes: a substrate layer including metal; an adhesive layer stacked on one surface of the substrate layer and including an acrylic adhesive polymer resin; and a release layer stacked on one surface of the adhesive layer, wherein the release layer includes a moisture barrier layer.

In the specification of the present disclosure, “(meth)acrylic” refers to “acrylic” and/or “methacrylic,” and “(meth)acrylate” refers to “acrylate” and/or “methacrylate.”

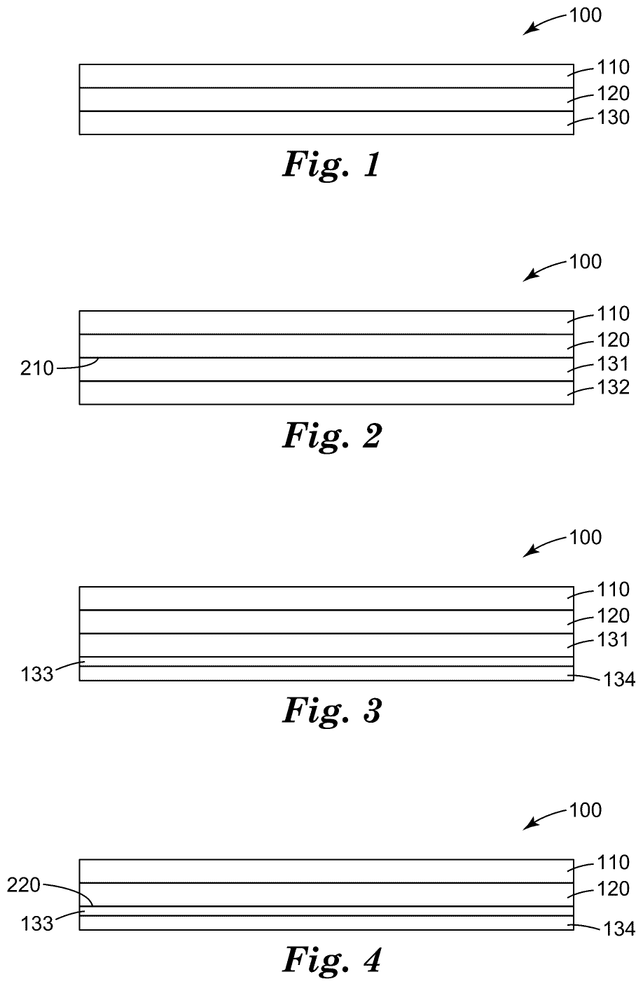

Referring to FIG. 1, a pressure sensitive adhesive tape 100 according to one embodiment of the present disclosure may have a structure in which a substrate layer 110 including metal, an adhesive layer 120 including an acrylic adhesive polymer resin, and a release layer 130 including a moisture barrier layer are stacked in sequence.

### Substrate Layer

The substrate layer functions to support the pressure sensitive adhesive tape, and includes metal and indicates electrical conductivity. Specifically, the substrate layer may be one or more selected from the group consisting of a conductive woven fabric, a conductive non-woven fabric, a conduction-treated woven fabric, a conduction-treated non-woven fabric, a metal foil, a metal film, and a conductive mesh film which is manufactured by coating a mesh having conductivity with a polymer resin.

A thickness of the substrate layer may be 1 μm to 1 mm, but may be thinner or thicker when necessary.

### Adhesive Layer

The adhesive layer may be stacked on one surface of the substrate layer, and may include an acrylic adhesive polymer resin.

The acrylic adhesive polymer resin may be a copolymer in which an alkyl acrylic acid ester monomer having an alkyl group of carbon numbers 1 to 14, and a polar copolymerization monomer including a carbonyl group are copolymerized. Specifically, the acrylic adhesive polymer resin may be a copolymer in which the alkyl acrylic acid ester monomer and the polar copolymerization monomer including the carbonyl group are copolymerized in a weight ratio of 99˜50:1˜50.

Specifically, the alkyl acrylic acid ester monomer may be one or more selected from the group consisting of butyl (meth)acrylate, hexyl(meth)acrylate, n-octyl (meth)acrylate, isooctyl (meth)acrylate, 2-ethylhexyl (meth)acrylate, isononyl (meth)acrylate, decyl (meth)acrylate, and dodecyl (meth)acrylate. More specifically, the alkyl acrylic acid ester monomer may be isooctyl acrylate, isononyl acrylate, 2-ethylhexyl acrylate, decyl acrylate, dodecyl acrylate, n-butyl acrylate, or hexyl acrylate.

The polar copolymerization monomer including the carbonyl group may enhance adhesion by adding stickiness and cohesion to the polymer resin. Specifically, the polar copolymerization monomer may be one or more selected from the group consisting of acrylic acid and itaconic acid.

The adhesive layer may include a conductive filler. The conductive filler may be arranged in the acrylic adhesive polymer resin in horizontal and vertical directions, thereby forming a network, and a current may flow through the network of the conductive filler. Accordingly, when the adhesive layer includes the conductive filler, the adhesive layer may have electrical conductivity.

The conductive filler may be selected from the group consisting of: metal including noble metal and non-noble metal; noble metal or non-noble metal plated with noble metal; noble metal or non-noble metal plated with non-noble metal; non-metal plated with noble metal or non-noble metal; conductive non-metal; a conductive polymer; and a mixture thereof. For example, the conductive filler may include: noble metal such as gold, silver, or platinum, and non-noble metal such as nickel, copper, tin, or aluminum; noble metal or non-noble metal plated with noble metal, such as silver-plated-copper, -nickel, -aluminum, -tin, or -gold; noble metal or non-noble metal plated with non-novel metal, such as nickel-plated-copper or -silver; non-metal plated with noble metal or non-noble metal, such as silver or nickel-plated-graphite, -glass, -ceramic, -plastic, -elastomer, -mica; conductive non-metal such as carbon black or carbon fiber; a conductive polymer such as polyacetylene, polyaniline, polypyrrole, polythiophene, polysulfurnitride, poly-p-phenylene, polyphenylenesulfide, poly-p-phenylenevinylene; or a mixture thereof.

The conductive filler may have a particle shape or a similar shape thereto. For example, the conductive filler may use a material that may be morphologically classified as a “particle type” in a wide sense. That is, any type of filler that has been used in order to give conductivity in the related art may be unlimitedly applied, and specifically, the filler may have a solid microsphere shape, a hollow microsphere shape, an elastomeric particle shape, an elastomeric balloon shape, a piece shape, a plate shape, a fiber shape, a bar shape, an indeterminate shape, etc.

A size of the conductive filler is not specifically limited, but, for example, an average diameter of the conductive filler may be 0.250 to 250 μm, and specifically, may be 1 to 100 μm.

The conductive filler may be included in an amount of 0.01 to 500 weight parts with respect to 100 weight parts of the acrylic adhesive polymer resin. Specifically, the conductive filler may be included in an amount of 0.1 to 100 weight parts with respect to 100 weight parts of the acrylic adhesive polymer resin.

A thickness of the adhesive layer may be 1 to 100 μm. Specifically, the thickness of the adhesive layer may be 2 to 50 μm.

The adhesive layer may further include, as other additives in a manufacturing process thereof, a polymerization initiator, a cross-linking agent, a photoinitiator, a pigment, an antioxidant, a UV stabilizer, a dispersing agent, an anti-foamer, a thickner, a plasticizer, a tackifying resin, a polishing agent, etc.

### Release Layer

The release layer may be stacked on one surface of the adhesive layer, and may include a moisture barrier layer. In one embodiment, the release layer may include a release film coated with silicon, and the moisture barrier layer. In one embodiment, the release layer may include a silicon coating layer formed on a surface contacting the adhesive layer. Specifically, the release layer may include the release film coated with silicon, which has the silicon coating layer positioned on one surface contacting the adhesive layer, and the moisture barrier layer. The moisture barrier layer may prevent moisture from permeating the adhesive layer.

Referring to FIG. 2, a pressure sensitive adhesive tape 100 according to one embodiment of the present disclosure may have a structure in which a substrate layer 110 including metal, an adhesive layer 120 including an acrylic adhesive polymer resin, a release film 131, and a moisture barrier layer 132 are stacked in sequence. In addition, the release film 131 may include a silicon coating layer formed on a surface 210 contacting the adhesive layer 120.

The release film may be one or more selected from the group consisting of a polyester (PET) film, a polyethylene (PE) film, a polypropylene (PP) film, and paper.

A thickness of the release film may be 5 to 100 μm, but may be thinner or thicker when necessary.

The moisture barrier layer may include a substrate film and a barrier coating layer.

A moisture permeability of the moisture barrier layer may be 0.01 to 6 g/m²·day. When the moisture permeability of the moisture barrier layer is within the above-mentioned range, reduction of adhesion of the adhesive layer caused by moisture in a high-humidity environment can be prevented, and thus adhesion of the adhesive tape can be enhanced.

Referring to FIG. 3, a pressure sensitive adhesive tape 100 according to one embodiment of the present disclosure may have a structure in which a substrate layer 110 including metal, an adhesive layer 120 including an acrylic adhesive polymer resin, a release film 131, a barrier coating layer 133, and a substrate film 134 are stacked in sequence, and the release film 131 may include a silicon coating layer formed on a surface contacting the adhesive layer 120.

Referring to FIG. 4, a pressure sensitive adhesive tape 100 according to one embodiment of the present disclosure may have a structure in which a substrate layer 110 including metal, an adhesive layer 120 including an acrylic adhesive polymer resin, a barrier coating layer 133 having one surface 220 release-treated, and a substrate film 134 are stacked in sequence. In this case, the release treatment may be a silicon coating treatment.

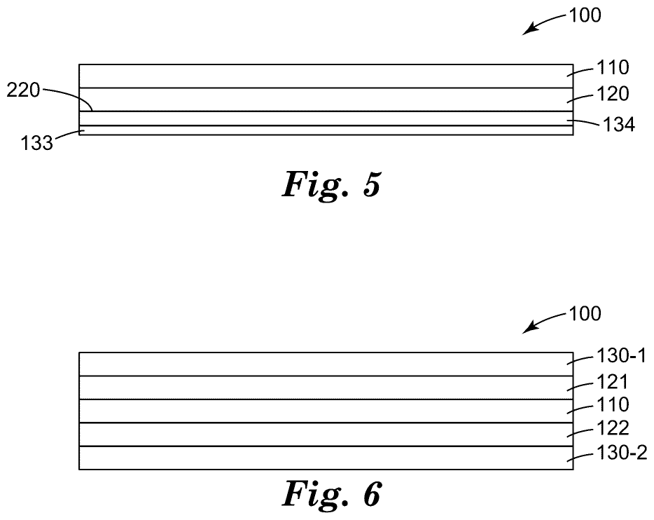

Referring to FIG. 5, a pressure sensitive adhesive tape 100 according to one embodiment of the present disclosure may have a structure in which a substrate layer 110 including metal, an adhesive layer 120 including an acrylic adhesive polymer resin, a substrate film 134 having one surface 220 release-treated, and a barrier coating layer 133 are stacked in sequence. In this case, the release treatment may be a silicon coating treatment. That is, the barrier coating layer 133 may be exposed.

The substrate film 134 may be one or more selected from the group consisting of a polyester (PET) film, a polyethylene (PE) film, a polypropylene (PP) film, and an oriented polyamide (OPA) film.

A thickness of the substrate film 134 may be 5 to 100 μm, but may be thinner or thicker when necessary.

The barrier coating layer 133 may be transparent. Specifically, the transparent barrier coating layer may include one or more selected from the group consisting of aluminum oxide (AlOₓ), silicon oxide (SiOₓ), ethylene vinyl alcohol (EVOH), polyvinyl alcohol (PVA), and polyvinylidene chloride (PVDC). When the barrier coating layer 133 is transparent, the adhesive layer 120 may be examined with naked eyes.

A thickness of the barrier coating layer 133 may be 5 to 500 nm, but may be thinner or thicker when necessary.

An average thickness of the adhesive tape may be 5 to 500 μm. Specifically, the average thickness of the adhesive tape may be 10 to 300 μm.

The adhesive tape may further include the adhesive layer and the release layer formed on the other surface of the substrate layer. Referring to FIG. 6, a pressure sensitive adhesive tape 100 according to one embodiment of the present disclosure may have a structure in which a first release layer 130-1 including a moisture barrier layer, a first adhesive layer 121 including an acrylic adhesive polymer resin, a substrate layer 110 including metal, a second adhesive layer 122 including an acrylic adhesive polymer resin, and a second release layer 130-2 including a moisture barrier layer are stacked in sequence. The first release layer and the second release layer are the same as the release layer described above, and the first adhesive layer and the second adhesive layer are the same as the adhesive layer described above.

Hereinafter, the present disclosure will be described in more detail with reference to the following examples. However, the following examples are merely examples, and the scope of the present disclosure is not limited thereto.

### EXAMPLES

### Manufacture Example 1. Manufacturing of an Acrylic Adhesive Polymer Resin Precursor

An acrylic adhesive polymer resin precursor solution was manufactured by mixing 390 g of an acrylic copolymer including a carboxyl group (Manufacturer: Doo Bong, Product Name: 1330W2), 5.85 g of an isocyanate cross-linking agent (Manufacturer: Geo Myung, Product Name: GT-75), 25 g of nickel powder (Manufacturer: Inco, Product Name: T123, Diameter: 2˜2.8 μm), and 150 g of toluene.

### Manufacture Example 2. Manufacturing of a Release Layer Including a Moisture Barrier Layer

A release layer of a thickness of 65 μm including a moisture barrier layer (hereinafter, referred to as a “moisture barrier silicon liner”) was manufactured by stacking a transparent barrier substrate film (Manufacturer: Toppen, Product Name: GX-P-F, Thickness: 12 μm) on the other surface of a release film having one surface coated with silicon (Manufacturer: SKC, Product Name: RF02N, Thickness: 38 μm) by using an urethane adhesive (Manufacturer: Henkel, Product Name: Tycel 393).

### Example 1. Manufacturing of an Adhesive Tape

The acrylic adhesive polymer resin precursor solution of manufacture example 1 was coated over the silicon coating layer of the moisture barrier silicon liner of manufacture example 2 in a typical notch bar coating method, and was dried by passing through an oven having three heating sections and being 6 meters long. Temperatures of the three sections were set to 40° C., 75° C., and 120° C. to be increased in sequence according to the length of the oven, and a line speed was 2 m/min. A thickness of the adhesive layer after drying was 12 μm.

Thereafter, an adhesive tape of a thickness of 87 μm including the moisture barrier silicon liner was manufactured by stacking a copper foil (thickness: 10 μm) on one surface of the adhesive layer, and by aging at 45° C. for 72 hours.

### Example 2

An adhesive tape of a thickness of 110 μm was manufactured by removing a release film of a copper foil tape (Manufacturer: 3M, Product Name: 3340BC), and stacking the silicon coating layer of the moisture barrier silicon liner of manufacture example 2.

### Comparison Example 1

An adhesive tape of a thickness of 72 μm was manufactured in the same way as in Example 1, except for that a release film (Manufacturer: SKC, Product Name: RF02N, Thickness: 50 μm) having one surface coated with silicon was used instead of the moisture barrier silicon liner of manufacture example 2.

### Comparison Example 2

An adhesive tape of a thickness of 95 μm was manufactured in the same way as in Example 2, except for that a release film (Manufacturer: SKC, Product Name: RF02N, Thickness: 50 μm) having one surface coated with silicon was used instead of the moisture barrier silicon liner of manufacture example 2.

### Test Example 1

180° peel adhesion and probe tack on stainless steel (SUS) were measured with respect to the adhesive tapes of examples 1 and 2 and comparison examples 1 and 2 in the following method three times or five times.

### (1) 180° Peel Adhesion

180° peel adhesion of the adhesive tapes of examples 1 and 2 and comparison examples 1 and 2 was measured based on ASTM D1000.

Specifically, each of the adhesive tapes of examples 1 and 2 and comparison examples 1 and 2 was cut into a piece 1 inch wide, and the piece was attached to SUS, and then was compressed by a reciprocating motion of a rubber roll of 2 kg at the speed of 12 inch/min, remained at 25° C. for 20 minutes, and then initial 180° peel adhesion was measured. After the piece was stored under the condition of 85° C. and 85% relative humidity for 24 or 72 hours, the adhesion was measured in the same way as described above.

### (2) Probe Tack

Probe tack was measured with respect to the adhesive tapes of example 1 and comparison example 1 by using a probe tack testing machine (Manufacturer: ChemInstruments, Model Name: Probe Tack).

The results of measurement are shown in tables 1 and 2 presented below:

TABLE 1

| | | | Comparison Example |
|---|---|---|---|
| | | Example 1 | 1 |
| Initial Adhesion | First time | 1471 | 1445 |
| (gf/inch) | Second time | 1418 | 1491 |
| | Third time | 1433 | 1501 |
| Adhesion after | First time | 1413 | 1090 |
| storage for 72 hours | Second time | 1479 | 1178 |
| (gf/inch) | Third time | 1545 | 1187 |
| Probe Tack (g) | First time | 211 | 231 |
| | Second time | 254 | 265 |
| | Third time | 286 | 297 |
| | Fourth time | 304 | 340 |
| | Fifth time | 388 | 371 |
| Probe Tack (g) after | First time | 162 | 42 |
| storage for 72 hours | Second time | 211 | 53 |
| | Third time | 273 | 92 |
| | Fourth time | 293 | 101 |
| | Fifth time | 328 | 122 |

TABLE 2

| | Example 2 | | | Comparison Example 2 | | |
|---|---|---|---|---|---|---|
| | First time | Second | Third | First time | Second | Third |
| Initial Adhesion (gf/inch) | 1313 | 1311 | 1347 | 1325 | 1319 | 1351 |
| Adhesion after storage for 24 | 1175 | 1187 | 1193 | 721 | 789 | 694 |
| hours (gf/inch) | | | | | | |
| Variation | 89.49% | 90.54% | 88.57% | 54.42% | 59.82% | 51.37% |

As shown in tables 1 and 2, the adhesive tapes of examples 1 and 2, including the release layer including the moisture barrier layer, had a small change in adhesion even when they remained for a long time in a high-humidity environment, and degradation of probe tack (stickiness) was slight. On the other hand, in the adhesive tapes of comparison examples 1 and 2, which do not include the moisture barrier layer, adhesion and probe tack were greatly degraded after they remained for a long time in a high-humidity environment.

Accordingly, the pressure sensitive adhesive tape according to the present disclosure can prevent reduction of adhesion of the adhesive layer caused by moisture in a high-humidity environment, and thus can have enhanced adhesion.

[Description of Reference Numerals]

| | |
|---|---|
| 100: Pressure sensitive adhesive tape | 110: Substrate Layer |
| 120: Adhesive layer | 121: First adhesive layer |
| 122: First adhesive layer | 130: Release Layer |
| 130-1: First release layer | 130-2: Second release layer |
| 131: Release film | 132: Moisture barrier layer |
| 133: Barrier coating layer | 134: Substrate film |

1. A pressure sensitive adhesive tape comprising:
a substrate layer comprising metal;
an adhesive layer stacked on one surface of the substrate layer, and comprising an acrylic adhesive polymer resin, the adhesive layer further comprising a conductive filler comprising metal; and
a release layer stacked on one surface of the adhesive layer,
wherein the release layer comprises a moisture barrier layer,
wherein the moisture barrier layer comprises a substrate film having one surface release-treated, and a barrier coating layer, and
wherein the pressure sensitive adhesive tape has a structure in which the substrate layer, the adhesive layer, the substrate film, and the barrier coating layer are stacked in sequence.

2. The pressure sensitive adhesive tape of claim 1, wherein the acrylic adhesive polymer resin comprises an acrylic copolymer including a carboxyl group.

3. The pressure sensitive adhesive tape of claim 1, wherein the barrier coating layer comprises aluminum oxide (AlOx).

4. The pressure sensitive adhesive tape of claim 1, wherein a moisture permeability of the moisture barrier layer is 0.01 to 6 g/m² day.

5. The pressure sensitive adhesive tape of claim 1, wherein the substrate layer comprises copper.

6. The pressure sensitive adhesive tape of claim 1, wherein the substrate layer has a thickness in a range of 1 μm to 1 mm.
